(19) United States
(12) Patent Application Publication
(10) Pub. No.: US 2026/0354375 A1
(43) Pub. Date: Nov. 12, 2026

(54) AGROCHEMICAL FORMULATIONS

(71) Applicant: BASF SE, Ludwigshafen am Rhein (DE)

(72) Inventors: Felix Salvadore HOFFMANN, Ludwigshafen am Rhein (DE); Claude TARANTA, Limburgerhof (DE)

(21) Appl. No.: 19/139,183

(22) PCT Filed: Dec. 4, 2023
(86) PCT No.: PCT/EP2023/084037

§ 371 Date: Jun. 13, 2025

(30) Foreign Application Priority Data
Dec. 15, 2022 (EP) 22213753.1

(51) Int. Cl. A01N 25/04; A01N 43/50; A01N 43/54; A01N 43/80; A01N 43/84; A01P 13/00

(52) U.S. Cl. CPC A01N 25/04; A01N 43/50; A01N 43/54; A01N 43/80; A01N 43/84; A01P 13/00

(57) ABSTRACT

Agrochemical formulation comprising
a) a continuous oil phase comprising a water-immiscible solvent;
b) an agrochemical active in the form of particles, which particles are suspended in the continuous oil phase; and
c) water droplets that are emulsified in the continuous oil phase;
d) one or more dispersants,
e) a clay.

The present invention relates to an agrochemical formulation; a method for producing the agrochemical formulation; a method for preparing the agrochemical formulation; a method for controlling phytopathogenic fungi and/or undesired plant growth and/or undesired attack by insects or mites and/or for regulating the growth of plants, a method for stabilizing an oil dispersion; and a method for increasing the viscosity of a continuous oil-phase. Preferred embodiments are described in the dependent claims. Combinations of embodiments with other embodiments are within the scope of the disclosure.

Many agrochemical actives are formulated as liquid concentrates. If the agrochemical active is not soluble in the liquid, it is often necessary to form a stable and homogeneous suspension of the agrochemical active in the continuous liquid phase. If the continuous liquid phase is an aqueous phase, these formulations are known in the art as suspension concentrates (SCs). If the continuous liquid phase is an oil phase, these formulations are known as oil dispersions (ODs). It is desirable that the applicant does not need to homogenize the liquid concentrate before use, since this will require additional time and handling, including exposure to toxic ingredients that may be present in the agrochemical formulation. A major problem for suspensions of particles is that the particles tend to form sediment over time by particle growth and/or settling of the particles. This tendency may be accompanied by caking of the sediment, i.e. the formation of solid sediment that cannot be easily resuspended by the applicant.

To prevent the formation of sediment (and particle-free serum in the supernatant), thickeners are often added to suspension concentrates and oil dispersions. Such thickeners increase the viscosity of the continuous liquid phase, which reduces the influence of gravitational sedimentation and particle-particle interactions in the suspension.

OD formulations are advantageous as compared to SC formulation in that no expensive biocides, many of those being under regulatory scrutinization (e.g. BIT, MIT, CIT) are required to protect the formulation from infestation by microorganisms and fungi. It has been described in WO 2020/126508 that emulsified water droplets in the continuous oil phase of OD formulations are able to stabilize the formulations. However, under certain conditions there is still a need for further stabilizing such OD formulations comprising water droplets.

It has now surprisingly been found that emulsified water droplets in the continuous oil phase of OD formulations are able to stabilize the formulations especially well in combination with clays, especially modified clays like organoclays.

The invention thus relates to an agrochemical formulation comprising
a) a continuous oil phase comprising a water-immiscible solvent;
b) an agrochemical active in the form of particles, which particles are suspended in the continuous oil phase; and
c) water droplets that are emulsified in the continuous oily phase;
d) one or more dispersants,
e) a clay.

In one embodiment, the invention thus relates to an agrochemical formulation comprising
a) a continuous oil phase comprising a water-immiscible solvent;
b) an agrochemical active in the form of particles, which particles are suspended in the continuous oil phase; and
c) water droplets that are emulsified in the continuous oily phase;
d) one or more dispersants,
e) a modified clay.

In one embodiment, the invention thus relates to an agrochemical formulation comprising
a) a continuous oil phase comprising a water-immiscible solvent;
b) an agrochemical active in the form of particles, which particles are suspended in the continuous oil phase; and
c) water droplets that are emulsified in the continuous oily phase;
d) one or more dispersants,
e) an organo clay.

The agrochemical formulation contains a continuous oil phase. The term “continuous oil phase” is known in the technical field of dispersions and refers to the dispersion medium in which particles or liquids are distributed in. In the present case, the continuous oil phase relates to the liquid in which both the water droplets and the agrochemical active is dispersed in.

The continuous oil phase comprises a water-immiscible solvent. The water immiscible solvent typically has a water-solubility of up to 50 g/l, preferably up to 20 g/l, more preferably up to 10 g/l, most preferably up to 1 g/l, and especially preferably up to 0.5 g/l at 20 °C.

Suitable examples for water-immiscible solvents include
hydrocarbon solvents such as aliphatic, cyclic and aromatic hydrocarbons (e. g. toluene, xylene, paraffin, tetrahydronaphthalene, alkylated naphthalenes or their derivatives, mineral oil fractions of medium to high boiling point (such as kerosene, diesel oil, coal tar oils));
vegetable oils, such as corn oil, rapeseed oil;
fatty acid esters such as C₁-C₁₀-alkylester of a C₁₀-C₂₂-fatty acid; or
   methyl- or ethyl esters of vegetable oils such as rapeseed oil methyl ester or corn oil methyl ester. Mixtures of aforementioned solvents are also possible. In one embodiment, the water-immiscible solvent is a vegetable oil. In another embodiment, the solvent is a hydrocarbon. In another embodiment, the water-immiscible solvent is a fatty acid ester. Particularly preferred water-immiscible solvents are soybean oil, methylated soybean oil, hydrocarbon solvents selected from aliphatic and cyclic hydrocarbons, or mixtures thereof. The continuous oil phase, in particular the water-insoluble solvent contained therein, may also function as a biological adjuvant for the agrochemical active, i.e. the biological efficacy of the agrochemical active may be increased by the continuous oil phase.

The agrochemical formulation typically contains at least 20 wt % of the water-immiscible solvent, preferably at least 30 wt %, more preferably at least 40 wt %, most preferably at least 50 wt % based on the total weight of the agrochemical formulation. The agrochemical formulation typically contains up to 95 wt % of the water-immiscible solvent, preferably up to 90 wt %, more preferably up to 85 wt %, most preferably up to 70 wt&, and especially preferably up to 60 wt %. Typically, the agrochemical formulation contains the water-immiscible solvent in a concentration of from 10 to 95 wt %, preferably of from 20 to 80 wt %, more preferably of from 30 to 60 wt % based on the total weight of the agrochemical formulation.

The continuous oil phase may comprise additional water-soluble solvents. The term “water-soluble solvents” does not comprise water per se and refers to organic solvents that have a certain solubility in water. The water-solubility of these additional solvents may be at least 50 g/l, preferably at least 100 g/l, more preferably at least 150 g/l, most preferably at least 200 g/l at 20 °C. Typical water-soluble solvents are propylene carbonate, dimethyl carbonate, ethylene carbonate, acetone, gamma-butyrolactone, tetrahydrofuran, N-methyl-2-pyrrolidon, acetonitrile, nitromethane, dimethyl formamide, dimethylacetamide, dimethylsulfoxide, sulfolane, and alcohols such as methanol, ethanol and isopropanol. Typically, the agrochemical formulation does not contain any additional water-soluble solvents. In one embodiment, the agrochemical formulation contains less than 10 wt %, preferably less than 1 wt %, more preferably less than 0.1 wt % of an additional water-soluble solvent based on the total weight of the total weight of the agrochemical formulation.

The agrochemical formulation contains an agrochemical active. The term “agrochemical active” refers to a substance that confers a desirable biological activity to the agrochemical formulation. Typically, the agrochemical active is a pesticide. Agrochemical actives may be selected from fungicides, insecticides, nematicides, herbicides, safeners, micronutrients, biopesticides and/or growth regulators. In one embodiment, the agrochemical active is an insecticide. In another embodiment, the agrochemical active is a fungicide, preferably metyltetraprole. In yet another embodiment the agrochemical active is a herbicide, preferably saflufenacil. In yet another embodiment, the agrochemical active is trifludimoxazin. The skilled worker is familiar with such pesticides, which can be found, for example, in the Pesticide Manual, 16th Ed. (2013), The British Crop Protection Council, London. Suitable insecticides are insecticides from the class of the carbamates, organophosphates, organochlorine insecticides, phenylpyrazoles, pyrethroids, neonicotinoids, spinosins, avermectins, milbemycins, juvenile hormone analogs, alkyl halides, organotin compounds nereistoxin analogs, benzoylureas, diacylhydrazines, METI acarizides, and insecticides such as chloropicrin, pymetrozin, flonicamid, clofentezin, hexythiazox, etoxazole, diafenthiuron, propargite, tetradifon, chlorfenapyr, DNOC, buprofezine, cyromazine, amitraz, hydramethylnon, acequinocyl, fluacrypyrim, rotenone, or their derivatives. Suitable fungicides are fungicides from the classes of dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzyl carbamates, carbamates, carboxamides, carboxylic acid diamides, chloronitriles cyanoacetamide oximes, cyanoimidazoles, cyclopropanecarboxamides, dicarboximides, dihydrodioxazines, dinitrophenyl crotonates, dithiocarbamates, dithiolanes, ethylphosphonates, ethylaminothiazolecarboxamides, guanidines, hydroxy-(2-amino)pyrimidines, hydroxyanilides, imidazoles, imidazolinones, inorganic substances, isobenzofuranones, methoxyacrylates, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiophanates, thiophenecarboxamides, toluamides, triphenyltin compounds, triazines, triazoles. Suitable herbicides are herbicides from the classes of the acetamides, amides, aryloxyphenoxypropionates, benzamides, benzofuran, benzoic acids, benzothiadiazinones, bipyridylium, carbamates, chloroacetamides, chlorocarboxylic acids, cyclohexanediones, dinitroanilines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas. Suitable plant growth regulators are antiauxins, auxins, cytokinins, defoliants, ethylene modulators, ethylene releasers, gibberellins, growth inhibitors, morphactins, growth retardants, growth stimulators, and further unclassified plant growth regulators. Suitable micronutrients are compounds comprising boron, zinc, iron, copper, manganese, chlorine, and molybdenum.

The following lists of pesticides that are suitable for use in formulations of the invention, is intended to illustrate the possible combinations but does not limit them:
A) Respiration inhibitors
   inhibitors of complex III at Qₒ site: azoxystrobin, coumethoxystrobin, coumoxystrobin, dimoxystrobin, enestroburin, fenaminstrobin, fenoxystrobin/flufenoxystrobin, fluoxastrobin, kresoxim-methyl, mandestrobin, metominostrobin, orysastrobin, picoxystrobin, pyraclostrobin, pyrametostrobin, pyraoxystrobin, trifloxystrobin, pyribencarb, triclopyricarb/chlorodincarb, famoxadone, fenamidone, pyriminostrobin, bifujunzhi, metyltetraprole;
   inhibitors of complex III at Qᵢ site: cyazofamid, amisulbrom, fenpicoxamid, florylpicoxamid, metarylpicoxamid;
   inhibitors of complex II: benodanil, benzovindiflupyr, bixafen, boscalid, carboxin, fenfuram, fluopyram, flutolanil, fluxapyroxad, furametpyr, isofetamid, isopyrazam, mepronil, oxycarboxin, penflufen, penthiopyrad, pydiflumetofen, pyraziflumid, sedaxane, tecloftalam, thifluzamide, inpyrfluxam, pyrapropoyne, fluindapyr, isoflucypram, cyclobutrifluram;
   other respiration inhibitors: diflumetorim; nitrophenyl derivates: binapacryl, dinobuton, dinocap, fluazinam, meptyldinocap; ferimzone; organometal compounds: fentin salts, e.g. fentin-acetate, fentin chloride or fentin hydroxide; silthiofam;
   quinone outside inhibitor stigmatellin binding type: ametoctradin;
B) Sterol biosynthesis inhibitors (SBI fungicides)
   C14 demethylase inhibitors: triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole, fluoxytioconazole, ipfentrifluconazole, mefentrifluconazole; imidazoles: imazalil, pefurazoate, prochloraz, triflumizol; pyrimidines, pyridines, piperazines: fenarimol, pyrifenox, triforine;
   Delta14-reductase inhibitors: aldimorph, dodemorph, dodemorph-acetate, fenpropimorph, tridemorph, fenpropidin, piperalin, spiroxamine;
   Inhibitors of 3-keto reductase: fenhexamid, fenpyrazamine;
   other Sterol biosynthesis inhibitors: chlorphenomizole;
C) Nucleic acid synthesis inhibitors
   RNA polymerase I inhibitors: benalaxyl, benalaxyl-M, kiralaxyl, metalaxyl, metalaxyl-M, ofurace, oxadixyl;
   other nucleic acid synthesis inhibitors: hymexazole, octhilinone, oxolinic acid, bupirimate, 5-fluorocytosine, ipflufenoquin, quinofumelin;
D) Inhibitors of cell division and cytoskeleton
   tubulin polymerization inhibitors: benomyl, carbendazim, fuberidazole, thiabendazole, thiophanate-methyl, pyridachlometyl;
   other cell division inhibitors: diethofencarb, ethaboxam, pencycuron, fluopicolide, zoxamide, metrafenone, pyriofenone, phenamacril, fluopimomide;
E) Inhibitors of amino acid and protein synthesis
   methionine synthesis inhibitors: cyprodinil, mepanipyrim, pyrimethanil;
   protein synthesis inhibitors: blasticidin-S, kasugamycin, kasugamycin hydrochloride-hydrate, mildiomycin, streptomycin, oxytetracyclin;
F) Signal transduction inhibitors
   MAP/histidine kinase inhibitors: fluoroimid, iprodione, procymidone, vinclozolin, fludioxonil;
   mechanism unknown: quinoxyfen, proquinazid;
G) Lipid and membrane synthesis inhibitors
   Phospholipid biosynthesis inhibitors: edifenphos, iprobenfos, pyrazophos, isoprothiolane;
   lipid peroxidation: dicloran, quintozene, tecnazene, tolclofos-methyl, biphenyl, chloroneb, etridiazole;
   compounds affecting cell membrane permeability and fatty acids: propamocarb;
   inhibitors of oxysterol binding protein: oxathiapiprolin, fluoxapiprolin;
H) Inhibitors with Multi Site Action
   inorganic active substances: Bordeaux mixture, copper, copper acetate, copper hydroxide, copper oxychloride, basic copper sulfate, sulfur;
   thio- and dithiocarbamates: ferbam, mancozeb, maneb, metam, metiram, propineb, thiram, zineb, ziram;
   organochlorine compounds: anilazine, chlorothalonil, captafol, captan, folpet, dichlofluanid, dichlorophen, hexachlorobenzene, pentachlorphenole and its salts, phthalide, tolylfluanid;
   guanidines and others: guanidine, dodine, dodine free bas, guazatine, guazatine-acetate, iminoctadine, iminoctadine-triacetate, iminoctadine-tris(albesilate), dithianon, fluoroimide, methasulfocarb, chinomethionat;
I) Cell wall synthesis inhibitors
   inhibitors of glucan synthesis: validamycin, polyoxin B;
   melanin synthesis inhibitors: pyroquilon, tricyclazole, carpropamid, dicyclomet, fenoxanil, tolprocarb;
   cellulose synthase inhibitors: dimethomorph, flumorph, mandipropamid, pyrimorph, benthiavalicarb, iprovalicarb, valifenalate;
J) Plant defence inducers
   acibenzolar-S-methyl, probenazol, isotianil, tiadinil, prohexadione-calcium; phosphonates: fosetyl, fosetyl-aluminum, phosphorous acid and its salts, calcium phosphonate, potassium phosphonate, potassium or sodium bicarbonate, dichlobentiazox;
K) Unknown mode of action
   bronopol, cyflufenamid, cymoxanil, dazomet, debacarb, diclocymet, diclomezine, difenzoquat, difenzoquat-methylsulfate, diphenylamin, fenitropan, fenpyrazamine, flumetover, flumetylsulforim, flusulfamide, flutianil, harpin, nitrapyrin, nitrothal-isopropyl, oxin-copper, seboctylamine, tebufloquin, tecloftalam, triazoxide, pyrisoxazole, benzisothiazolinone, bromothalonil, aminopyrifen, flufenoxadiazam;
L) Biopesticides
   L1) Microbial pesticides with fungicidal, bactericidal, viricidal and/or plant defense activator activity: Ampelomyces quisqualis, Aspergillus flavus, Aureobasidium pullulans, Bacillus altitudinis, B. amyloliquefaciens, B. amyloliquefaciens ssp. plantarum (also referred to as B. velezensis), B. megaterium, B. mojavensis, B. mycoides, B. pumilus, B. simplex, B. soli-salsi, B. subtilis, B. subtilis var. amyloliquefaciens, B. velezensis, Candida oleophila, C. saitoana, Clavibacter michiganensis (bacteriophages), Coniothyrium minitans, Cryphonectria parasitica, Cryptococcus albidus, Dilophosphora alopecuri, Fusarium oxysporum, Clonostachys rosea f. catenulate (also named Gliocladium catenulatum), Gliocladium roseum, Lysobacter antibioticus, L. enzymogenes, Metschnikowia fructicola, Microdochium dimerum, Microsphaeropsis ochracea, Muscodor albus, Paenibacillus alvei, Paenibacillus epiphyticus, P. polymyxa, Pantoea vagans, Penicillium bilaiae, Phlebiopsis gigantea, Pseudomonas sp., Pseudomonas chloraphis, Pseudozyma flocculosa, Pichia anomala, Pythium oligandrum, Sphaerodes mycoparasitica, Streptomyces griseoviridis, S. lydicus, S. violaceusniger, Talaromyces flavus, Trichoderma asperelloides, T. asperellum, T. atroviride, T. fertile, T. gamsii, T. harmatum, T. harzianum, T. polysporum, T. stromaticum, T. virens, T. viride, Typhula phacorrhiza, Ulocladium oudemansii, Verticillium dahlia, zucchini yellow mosaic virus (avirulent strain);
   L2) Biochemical pesticides with fungicidal, bactericidal, viricidal and/or plant defense activator activity: harpin protein, Reynoutria sachalinensis extract;
   L3) Microbial pesticides with insecticidal, acaricidal, molluscidal and/or nematicidal activity: Agrobacterium radiobacter, Bacillus cereus, B. firmus, B. thuringiensis, B. thuringiensis ssp. aizawai, B. t. ssp. israelensis, B. t. ssp. galleriae, B. t. ssp. kurstaki, B. t. ssp. tenebrionis, Beauveria bassiana, B. brongniartii, Burkholderia spp., Chromobacterium subtsugae, Cydia pomonella granulovirus, Cryptophlebia leucotreta granulovirus, Flavobacterium spp., Helicoverpa armigera nucleopolyhedrovirus, Helicoverpa zea nucleopolyhedrovirus, Helicoverpa zea single capsid nucleopolyhedrovirus, Heterorhabditis bacteriophora, Isaria fumosorosea, Lecanicillium longisporum, L. muscarium, Metarhizium anisopliae, M. anisopliae var. anisopliae, M. anisopliae var. acridum, Nomuraea rileyi, Paecilomyces fumosoroseus, P. lilacinus, Paenibacillus popilliae, Pasteuria spp., P. nishizawae, P. penetrans, P. ramosa, P. thornea, P. usgae, Pseudomonas fluorescens, Spodoptera littoralis nucleopolyhedrovirus, Steinernema carpocapsae, S. feltiae, S. kraussei, Streptomyces galbus, S. microflavus;
   L4) Biochemical pesticides with insecticidal, acaricidal, molluscidal, pheromone and/or nematicidal activity: L-carvone, citral, (E,Z)-7,9-dodecadien-1-yl acetate, ethyl formate, (E,Z)-2,4-ethyl decadienoate (pear ester), (Z,Z,E)-7,11,13-hexadecatrienal, heptyl butyrate, isopropyl myristate, lavanulyl senecioate, cis-jasmone, 2-methyl 1-butanol, methyl eugenol, methyl jasmonate, (E,Z)-2,13-octadecadien-1-ol, (E,Z)-2,13-octadecadien-1-ol acetate, (E,Z)-3,13-octadecadien-1-ol, (R)-1-octen-3-ol, pentatermanone, (E,Z,Z)-3,8,11-tetradecatrienyl acetate, (Z,E)-9,12-tetradecadien-1-yl acetate, (Z)-7-tetradecen-2-one, (Z)-9-tetradecen-1-yl acetate, (Z)-11-tetradecenal, (Z)-11-tetradecen-1-ol, extract of Chenopodium ambrosiodes, Neem oil, Quillay extract;
   L5) Microbial pesticides with plant stress reducing, plant growth regulator, plant growth promoting and/or yield enhancing activity: Azospirillum amazonense, A. brasilense, A. lipoferum, A. irakense, A. halopraeferens, Bradyrhizobium spp., B. elkanii, B. japonicum, B. liaoningense, B. lupini, Delftia acidovorans, Glomus intraradices, Mesorhizobium spp., Rhizobium leguminosarum bv. phaseoli, R. I. bv. trifolii, R. I. bv. viciae, R. tropici, Sinorhizobium meliloti;
O) Insecticides from classes O.1 to O.29
O.1 Acetylcholine esterase (AChE) inhibitors: aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb, triazamate; acephate, azamethiphos, azinphos-ethyl, azinphosmethyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothio-phosphoryl) salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, vamidothion;
O.2 GABA-gated chloride channel antagonists: endosulfan, chlordane; ethiprole, fipronil, flufiprole, pyrafluprole, pyriprole;
O.3 Sodium channel modulators: acrinathrin, allethrin, d-cis-trans allethrin, d-trans allethrin, bifenthrin, kappa-bifenthrin, bioallethrin, bioallethrin S-cyclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate, flucythrinate, flumethrin, tau-fluvalinate, halfenprox, heptafluthrin, imiprothrin, meperfluthrin, metofluthrin, momfluorothrin, epsilon-momfluorothrin, permethrin, phenothrin, prallethrin, profluthrin, pyrethrin (pyrethrum), resmethrin, silafluofen, tefluthrin, kappa-tefluthrin, tetramethylfluthrin, tetramethrin, tralomethrin, transfluthrin; DDT, methoxychlor;
O.4 Nicotinic acetylcholine receptor (nAChR) agonists: acetamiprid, clothianidin, cycloxaprid, dinotefuran, imidacloprid, nitenpyram, thiacloprid, thiamethoxam; nicotine; sulfoxaflor, flupyradifurone, triflumezopyrim, fenmezoditiaz, flupyrimin;
O.5 Nicotinic acetylcholine receptor allosteric activators: spinosad, spinetoram;
O.6 Chloride channel activators: abamectin, emamectin benzoate, ivermectin, lepimectin, milbemectin;
O.7 Juvenile hormone mimics: hydroprene, kinoprene, methoprene; fenoxycarb, pyriproxyfen;
O.8 miscellaneous non-specific (multi-site) inhibitors: methyl bromide and other alkyl halides; chloropicrin, sulfuryl fluoride, borax, tartar emetic;
O.9 Chordotonal organ TRPV channel modulators: afidopyropen, pymetrozine, pyrifluquinazon;
O.10 Mite growth inhibitors: clofentezine, hexythiazox, diflovidazin; etoxazole;
O.11 Microbial disruptors of insect midgut membranes: Bacillus thuringiensis, B. sphaericus and the insecticidal proteins they produce: Bacillus thuringiensis subsp. israelensis, B. sphaericus, B. thuringiensis subsp. aizawai, B. thuringiensis subsp. kurstaki, B. thuringiensis subsp. tenebrionis, the Bt crop proteins: Cry1Ab, Cry1Ac, Cry1Fa, Cry2Ab, mCry3A, Cry3Ab, Cry3Bb, Cry34/35Ab1;
O.12 Inhibitors of mitochondrial ATP synthase: diafenthiuron; azocyclotin, cyhexatin, fenbutatin oxide, propargite, tetradifon;
O.13 Uncouplers of oxidative phosphorylation via disruption of the proton gradient: chlorfenapyr, DNOC, sulfluramid;
O.14 Nicotinic acetylcholine receptor (nAChR) channel blockers: bensultap, cartap hydrochloride, thiocyclam, thiosultap sodium;
O.15 Inhibitors of the chitin biosynthesis type 0: bistrifluron, chlorfluazuron, diflubenzuron, flucycloxuron, flufenoxuron, hexaflumuron, lufenuron, novaluron, noviflumuron, teflubenzuron, triflumuron;
O.16 Inhibitors of the chitin biosynthesis type 1: buprofezin;
O.17 Moulting disruptors: cyromazine;
O.18 Ecdyson receptor agonists: methoxyfenozide, tebufenozide, halofenozide, fufenozide, chromafenozide;
O.19 Octopamin receptor agonists: amitraz;
O.20 Mitochondrial complex III electron transport inhibitors: hydramethylnon, acequinocyl, fluacrypyrim, bifenazate;
O.21 Mitochondrial complex I electron transport inhibitors: fenazaquin, fenpyroximate, pyrimidifen, pyridaben, tebufenpyrad, tolfenpyrad; rotenone;
O.22 Voltage-dependent sodium channel blockers: indoxacarb, metaflumizone;
O.23 Inhibitors of the of acetyl CoA carboxylase: spirodiclofen, spiromesifen, spirotetramat, spiropidion, spirobudifen, spidoxamat;
O.24 Mitochondrial complex IV electron transport inhibitors: aluminium phosphide, calcium phosphide, phosphine, zinc phosphide, cyanide;
O.25 Mitochondrial complex II electron transport inhibitors: cyenopyrafen, cyflumetofen, cyetpyrafen, pyflubumide;
O.28 Ryanodine receptor-modulators: chlorantraniliprole, cyantraniliprole, cyclaniliprole, flubendiamide, fluchlodiniliprole; tetrachlorantraniliprole; tetraniliprole; tiorantraniliprole; cyhalodiamide;
O.29 Chordotonal organ modulators: flonicamid;
O.30 GABA-gated chloride channel allosteric modulators: broflanilide, fluxametamide, isocycloseram;
O.33 Calcium-activated potassium channel modulators: acynonapyr;
O.34 Mitochondrial complex III electron transport inhibitors at Qi site: flometoquin;
O.UN Insecticidal compounds of unknown or uncertain mode of action: afoxolaner, azadirachtin, amidoflumet, benzoximate, bromopropylate, chinomethionat, cryolite, cyproflanilid, dicloromezotiaz, dicofol, dimpropyridaz, flufenerim, flometoquin, fluensulfone, fluhexafon, fluopyram, fluralaner, metaldehyde, metoxadiazone, piperonyl butoxide, pyridalyl, tioxazafen, trifluenfuronate, umifoxolaner, actives on basis of Bacillus firmus (Votivo); fluazaindolizine; tyclopyrazoflor; sarolaner, lotilaner; benzpyrimoxan; tigolaner; oxazosulfyl; cyproflanilide, nicofluprole; indazapyroxamet; flupentiofenox; cyclobutrifluram.
P) Herbicides from the classes P1 to P15
P1) lipid biosynthesis inhibitors:
   ACC-herbicides: alloxydim, alloxydim-sodium, butroxydim, clethodim, clodinafop, clodinafop-propargyl, cycloxydim, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, pinoxaden, profoxydim, propaquizafop, quizalofop, quizalofop-ethyl, quizalofop-tefuryl, quizalofop-P, quizalofop-P-ethyl, quizalofop-P-tefuryl, sethoxydim, tepraloxydim, tralkoxydim;
   non ACC herbicides: benfuresate, butylate, cycloate, dalapon, dimepiperate, EPTC, esprocarb, ethofumesate, flupropanate, molinate, orbencarb, pebulate, prosulfocarb, TCA, thiobencarb, tiocarbazil, triallate and vernolate;
P2) ALS inhibitors:
   sulfonylureas: amidosulfuron, azimsulfuron, bensulfuron, bensulfuron-methyl, chlorimuron, chlorimuron-ethyl, chlorsulfuron, cinosulfuron, cyclosulfamuron, ethametsulfuron, ethametsulfuron-methyl, ethoxysulfuron, flazasulfuron, flucetosulfuron, flupyrsulfuron, flupyrsulfuron-methyl-sodium, foramsulfuron, halosulfuron, halosulfuron-methyl, imazosulfuron, iodosulfuron, iodosulfuron-methyl-sodium, iofensulfuron, iofensulfuron-sodium, mesosulfuron, metazosulfuron, metsulfuron, metsulfuron-methyl, nicosulfuron, orthosulfamuron, oxasulfuron, primisulfuron, primisulfuron-methyl, propyrisulfuron, prosulfuron, pyrazosulfuron, pyrazosulfuron-ethyl, rimsulfuron, sulfometuron, sulfometuron-methyl, sulfosulfuron, thifensulfuron, thifensulfuron-methyl, triasulfuron, tribenuron, tribenuron-methyl, trifloxysulfuron, triflusulfuron, triflusulfuron-methyl and tritosulfuron;
   imidazolinones: imazamethabenz, imazamethabenz-methyl, imazamox, imazapic, imazapyr, imazaquin and imazethapyr;
   triazolopyrimidine herbicides and sulfonanilides: cloransulam, cloransulam-methyl, diclosulam, flumetsulam, florasulam, metosulam, penoxsulam, pyrimisulfan and pyroxsulam;
   pyrimidinylbenzoates: bispyribac, bispyribac-sodium, pyribenzoxim, pyriftalid, pyriminobac, pyriminobac-methyl, pyrithiobac, pyrithiobac-sodium;
   sulfonylaminocarbonyl-triazolinone herbicides: flucarbazone, flucarbazone-sodium, propoxycarbazone, propoxycarbazone-sodium, thiencarbazone and thiencarbazone-methyl;
   and triafamone;
P3) photosynthesis inhibitors:
amicarbazone, inhibitors of the photosystem II, triazine herbicides, including of chlorotriazine, triazinones, triazindiones, methylthiotriazines and pyridazinones such as ametryn, atrazine, chloridazone, cyanazine, desmetryn, dimethametryn, hexazinone, metribuzin, prometon, prometryn, propazine, simazine, simetryn, terbumeton, terbuthylazin, terbutryn and trietazin, aryl urea such as chlorobromuron, chlorotoluron, chloroxuron, dimefuron, diuron, fluometuron, isoproturon, isouron, linuron, metamitron, methabenzthiazuron, metobenzuron, metoxuron, monolinuron, neburon, siduron, tebuthiuron and thiadiazuron, phenyl carbamates such as desmedipham, karbutilat, phenmedipham, phenmedipham-ethyl, nitrile herbicides such as bromofenoxim, bromoxynil and its salts and esters, ioxynil and its salts and esters, uraciles such as bromacil, lenacil and terbacil, and bentazon and bentazon-sodium, pyridate, pyridafol, pentanochlor and propanil and inhibitors of the photosystem I such as diquat, diquat-dibromide, paraquat, paraquat-dichloride and paraquat-dimetilsulfate;
P4) protoporphyrinogen-IX oxidase inhibitors:
acifluorfen, acifluorfen-sodium, azafenidin, bencarbazone, benzfendizone, bifenox, butafenacil, carfentrazone, carfentrazone-ethyl, chlomethoxyfen, chlorphthalim, cinidon-ethyl, cyclopyranil, fluazolate, flufenpyr, flufenpyr-ethyl, flumiclorac, flumiclorac-pentyl, flumioxazin, fluoroglycofen, fluoroglycofen-ethyl, fluthiacet, fluthiacet-methyl, fomesafen, halosafen, lactofen, oxadiargyl, oxadiazon, oxyfluorfen, pentoxazone, profluazol, pyraclonil, pyraflufen, pyraflufen-ethyl, saflufenacil, sulfentrazone, thidiazimin, tiafenacil, trifludimoxazin, epyrifenacil;
P5) bleacher herbicides:
   PDS inhibitors: beflubutamid, diflufenican, fluridone, flurochloridone, flurtamone, norflurazon, picolinafen, rimisoxafen;
   HPPD inhibitors: benzobicyclon, benzofenap, bicyclopyrone, clomazone, fenquinotrione, isoxaflutole, mesotrione, oxotrione, pyrasulfotole, pyrazolynate, pyrazoxyfen, sulcotrione, tefuryltrione, tembotrione, tolpyralate, topramezone, bipyrazone, fenpyrazone, cypyrafluone, tripyrasulfone, benquitrione, dioxopyritrione;
   bleacher, unknown target: aclonifen, amitrole flumeturon, bixlozone;
P6) EPSP synthase inhibitors:
glyphosate, glyphosate-isopropylammonium, glyposate-potassium and glyphosate-trimesium (sulfosate);
P7) glutamine synthase inhibitors: bilanaphos (bialaphos), bilanaphos-sodium, glufosinate, glufosinate-P and glufosinate-ammonium;
P8) DHP synthase inhibitors: asulam;
P9) mitosis inhibitors:
   group K1: dinitroanilines: benfluralin, butralin, dinitramine, ethalfluralin, fluchloralin, oryzalin, pendimethalin, prodiamine and trifluralin; phosphoramidates: amiprophos, amiprophos-methyl, and butamiphos; benzoic acid herbicides: chlorthal, chlorthal-dimethyl; pyridines: dithiopyr and thiazopyr; benzamides: propyzamide and tebutam;
   group K2: carbetamide, chlorpropham, flamprop, flamprop-isopropyl, flamprop-methyl, flamprop-M-isopropyl, flamprop-M-methyl and propham;
P10) VLCFA inhibitors:
   chloroacetamides: acetochlor, alachlor, amidochlor, butachlor, dimethachlor, dimethenamid, dimethenamid-P, metazachlor, metolachlor, metolachlor-S, pethoxamid, pretilachlor, propachlor, propisochlor and thenylchlor,
   oxyacetanilides: flufenacet and mefenacet;
   acetanilides: diphenamid, naproanilide, napropamide and napropamide-M;
   tetrazolinones: fentrazamide;
   other herbicides: anilofos, cafenstrole, fenoxasulfone, ipfencarbazone, piperophos, pyroxasulfone, dimesulfazet and isoxazoline;
P11) cellulose biosynthesis inhibitors: chlorthiamid, dichlobenil, flupoxam, indaziflam, isoxaben, triaziflam;
P12) decoupler herbicides: dinoseb, dinoterb and DNOC and its salts;
P13) auxinic herbicides:
2,4-D and its salts and esters such as clacyfos, 2,4-DB and its salts and esters, aminocyclopyrachlor and its salts and esters, aminopyralid and its salts such as aminopyralid-dimethylammonium, aminopyralid-tris(2-hydroxypropyl)ammonium and its esters, benazolin, benazolin-ethyl, chloramben and its salts and esters, clomeprop, clopyralid and its salts and esters, dicamba and its salts and esters, dichlorprop and its salts and esters, dichlorprop-P and its salts and esters, flopyrauxifen, fluroxypyr, fluroxypyr-butometyl, fluroxypyr-meptyl, halauxifen and its salts and esters; MCPA and its salts and esters, MCPA-thioethyl, MCPB and its salts and esters, mecoprop and its salts and esters, mecoprop-P and its salts and esters, picloram and its salts and esters, quinclorac, quinmerac, TBA (2,3,6) and its salts and esters, triclopyr and its salts and esters, florpyrauxifen, florpyrauxifen-benzyl and 4-amino-3-chloro-5-fluoro-6-(7-fluoro-1H-indol-6-yl)picolinic acid;
P14) auxin transport inhibitors: diflufenzopyr, diflufenzopyr-sodium, naptalam and naptalam-sodium;
P15) other herbicides: bromobutide, chlorflurenol, chlorflurenol-methyl, cinmethylin, cumyluron, cyclopyrimorate and its salts and esters, dalapon, dazomet, difenzoquat, difenzoquat-metilsulfate, dimethipin, DSMA, dymron, endothal and its salts, etobenzanid, flurenol, flurenol-butyl, flurprimidol, fosamine, fosamine-ammonium, indanofan, maleic hydrazide, mefluidide, metam, methiozolin, methyl azide, methyl bromide, methyl-dymron, methyl iodide, MSMA, oleic acid, oxaziclomefone, pelargonic acid, pyributicarb, quinoclamine, tetflupyrolimet, tridiphane.
Q) Safeners
(quinolin-8-oxy)acetic acids, 1-phenyl-5-haloalkyl-1H-1,2,4-triazol-3-carboxylic acids, 1-phenyl-4,5-dihydro-5-alkyl-1H-pyrazol-3,5-dicarboxylic acids, 4,5-dihydro-5,5-diaryl-3-isoxazol carboxylic acids, dichloroacetamides, alpha-oximinophenylacetonitriles, acetophenonoximes, 4,6-dihalo-2-phenylpyrimidines, N-[[4-(aminocarbonyl)phenyl]sulfonyl]-2-benzoic amides, 1,8-naphthalic anhydride, 2-halo-4-(haloalkyl)-5-thiazol carboxylic acids, phosphorthiolates and N-alkyl-O-phenylcarbamates and their agriculturally acceptable salts and their agriculturally acceptable derivatives such amides, esters, and thioesters, provided they have an acid group.

In one embodiment, the agrochemical active comprises metyltetraprole, saflufenacil, trifludimoxazine, Imazethapyr, Pyroxasulfone or mixtures thereof.

In one embodiment, the agrochemical active comprises a mixture of saflufenacil, trifludimoxazine, Imazethapyr and Pyroxasulfone.

The agrochemical formulation may comprise the agrochemical active in a concentration of at least 1 wt %, preferably at least 5 wt % more preferably at least 10 wt %, most preferably at least 25 wt %, and in particular at least 40 wt % based on the total weight of the agrochemical formulation. The agrochemical formulation may comprise the agrochemical active in a concentration of up to 70 wt %, preferably up to 60 wt %, more preferably up to 50 wt % based on the total weight of the agrochemical formulation. The agrochemical formulation may comprise the agrochemical active in a concentration of from 1 to 70 wt %, preferably 1 to 60 wt %, more preferably 5 to 50 wt % based on the total weight of the composition.

The agrochemical active has a very low solubility in the continuous oil phase. Since the continuous oil phase is very lipophilic, the solubility of the agrochemical active is best measured in a lipophilic hydrocarbon such as n-octane. The agrochemical active typically has a solubility in n-octane at 20 °C of up to 1 g/l, preferably up to 10 mg/l, most preferably up to 100 μg/l. The agrochemical active typically also has a very low water-solubility of up to 10 g/l, preferably up to 5 g/l at 20 °C.

The agrochemical active is present in the form of particles that are suspended in the continuous oil phase. The particles can be characterized by their size distributions, which can be determined by dynamic light scattering methods. The D50-value is a statistical figure that indicates a maximum particle diameter that characterizes 50% by volume of all particles. In other words, 50% (v/v) of all particles have a diameter that is equal or smaller than the D50 value. The D50 value for the particles in the instant case is typically up to 30 μm, preferably up to 25 μm, more preferably up to 20 μm, most preferably up to 10 μm, and especially preferably up to 7 μm. The D50 value for the particles is typically at least 0.1 μm, preferably at least 0.8 μm, more preferably at least 1 μm. The D50 value for the particles is typically from 0.5 to 10 μm, preferably from 1 to 8 μm, more preferably from 1.5 to 5 μm.

The agrochemical formulation may also comprise a further agrochemical active in the emulsified water droplets. The further agrochemical active may be selected from fungicides, insecticides, nematicides, herbicides, safeners, micronutrients, biopesticides and/or growth regulators. In one embodiment, the further agrochemical active is an insecticide. In another embodiment, the further agrochemical active is a fungicide. In yet another embodiment the further agrochemical active is a herbicide, preferably dicamba, more preferably a salt of dicamba.

The further agrochemical active is typically water-soluble. The further agrochemical active may have a water-solubility at 20 °C of at least 10 g/l, preferably at least 50 g/l, more preferably at least 100 g/l. Usually, the further agrochemical active is present in dissolved form in the emulsified water droplets.

The agrochemical formulation may comprise the further agrochemical active in a concentration of from 1 to 30 wt %, preferably 1 to 20 wt %, most preferably 1 to 15 wt % based on the total weight of the agrochemical formulation. The agrochemical formulation may comprise the further agrochemical active in a concentration of at least 2 wt %, preferably at least 5 wt % based on the total weight of the agrochemical formulation. The agrochemical formulation may comprise the further agrochemical active in a concentration of up to 25 wt %, preferably up to 10 wt % based on the total weight of the agrochemical formulation.

The agrochemical formulation contains water droplets that are emulsified in the continuous oil phase. The agrochemical formulation typically contains at least 1 wt % of water in the form of water droplets, preferably at least 3 wt % of water in the form of droplets, more preferably at least 5 wt % of water in the form of droplets. The agrochemical formulation typically contains up to 50 wt % of water in the form of water droplets, preferably up to 40 wt % of water in the form of droplets, more preferably up to 30 wt % of water in the form of droplets. The agrochemical formulation typically contains from 1 to 60 wt % of water in the form of water droplets, preferably from 1 to 50 wt % of water in the form of droplets, more preferably from 3 to 30 wt % of water in the form of droplets, most preferably from 5 to 30 wt %, utmost preferably from 5 to 20 wt %.

The water droplets may be characterized by their size distribution similarly to the particles comprising the agrochemical active. The D50 value for the water droplets is typically up to 50 μm, preferably up to 40 μm, more preferably up to 30 μm, most preferably up to 20 μm, and especially preferably up to 10 μm, such as up to 5 μm. The D50 value for the water droplets is typically at least 0.1 μm, preferably at least 0.8 μm, more preferably at least 1 μm. The D50 value for the water droplets is typically from 0.5 to 50 μm, preferably from 1 to 30 μm, more preferably from 1.5 to 20 μm.

The agrochemical formulation comprises one or more dispersants. Dispersants include W/O-emulsifiers, O/W-emulsifiers and suspending agents. In one embodiment the agrochemical formulation comprises as dispersants one or more W/O emulsifiers. In one embodiment the agrochemical formulation comprises as dispersants one or more O/W emulsifiers. In one embodiment the agrochemical formulation comprises as dispersants one or more suspending agents. In one embodiment the agrochemical formulation comprises as dispersants one or more W/O emulsifiers, one or more O/W emulsifiers and one or more suspending agents.

The water droplets are emulsified in the continuous oil phase. Typically, the agrochemical formulation contains a water-in-oil emulsifier (W/O-emulsifier). Such emulsifiers are generally known to the skilled person. They may be characterized by their “hydrophilic-lipophilic balance” values (“HLB value”) as described by Michael E. Aulton, Pharmaceutics—The Science of Dosage Form Design, Second Edition, Churchill Livingston, 2001, p. 95-99. The HLB value of the W/O emulsifier is typically from 1 to 12, more preferably from 1 to 11, most preferably from 1 to 10. The HLB value of the W/O-emulsifier may be up to 9, preferably up to 7. Typically, the W/O-emulsifier is a non-ionic amphoteric emulsifier, preferably containing a polyethylene oxide moiety.

Suitable W/O emulsifiers may preferably be selected from fatty alcohol alkoxylates, preferably ethoxylated C₁₂-C₁₈ alcohols, such as isotridecyl alcohol that is ethoxylated with two ethylene oxide moieties (e.g. the Lutensol TO series of BASF); polyalkoxylates, preferably copolymers of ethylene oxide and propylene oxide (e.g. Step Flow LF or Genapol PF10); copolymers and block copolymers of glycerol with hydroxylated saturated and unsaturated fatty acids, such as polyglyceryl-2 dipolyhydroxystearate (e.g. Dehymuls PGPH), ethoxylated glycerol esters of hydroxy fatty acids and their derivatives, such as ethoxylated castor oil, ethoxylated and hydrogenated castor oil, or ethoxylated castor oil oleate (e.g. Toxium 8248, Toximul 8243, Alkamuls VO2003 or Emulsogen EL0200); polyether siloxanes (e.g. Break Thru OE 440), nonionic modified polyesters (e.g. Tersperse 2520), or polyglycerol fatty acid partial esters (e.g. Tego XP11041).

The agrochemical formulation comprises the W/O-emulsifier typically in a concentration of at least 1 wt %, preferably at least 2 wt %, more preferably at least 3 wt % based on the total weight of the agrochemical formulation. The agrochemical formulation may comprise the W/O emulsifier in a concentration of up to 20 wt %, preferably up to 15 wt %, more preferably up to 10 wt %, most preferably up to 8 wt % based on the total weight of the agrochemical formulation. The agrochemical formulation typically comprises the W/O emulsifier in a concentration of 1 to 12 wt %, preferably 1 to 10 wt %, more preferably 2 to 7 wt % based on the total weight of the agrochemical formulation.

The weight ratio of the W/O-emulsifier to the water that is in the form of emulsified water droplets is typically from 1:10 to 1:1, preferably from 1:10 to 1:2, more preferably from 1:6 to 1:2.

Since most applicants dilute the agrochemical formulation in an aqueous tank-mix composition prior to use, it is advantageous to add an oil-in-water emulsifier (O/W-emulsifier) to the agrochemical formulation. Such emulsifiers are also generally known to the skilled person. The HLB value of the O/W-emulsifier is typically from 7 to 17, more preferably from 8 to 16, most preferably from 10 to 16. The HLB value of the W/O-emulsifier is typically up to 19, preferably up to 18. The HLB value of the W/O-emulsifier is typically at least 9, preferably at least 10, more preferably at least 11.

Examples of suitable O/W-emulsifiers are ethoxylated sorbitans partial esters and peresters, preferably ethoxylated sorbitans oleates (e.g. Tween 85 or Arlatone TV), alkoxylated fatty alcohols and alkyl-aryl-sulfonates or mixtures thereof (e.g. Atlox 3467), ethoxylated glycerol esters of hydroxy fatty acids and their derivatives, such as ethoxylated castor oil, ethoxylated and hydrogenated castor oil, or ethoxylated castor oil oleate (e.g. Alkamuls VO 2003), N-hydroxyalkyl amides of saturated and unsaturated fatty acids, preferably N,N-bisdihydroxyethyl amides of saturated and unsaturated fatty acids (e.g. Surfom OD 8104).

The agrochemical formulation typically comprises the O/W-emulsifier in a concentration of at least 1 wt %, preferably at least 2 wt %, more preferably at least 3 wt % based on the total weight of the agrochemical formulation. The agrochemical formulation typically comprises the O/W-emulsifier in a concentration of up to 20 wt %, preferably up to 15 wt %, more preferably up to 10 wt %, most preferably up to 8 wt % based on the total weight of the agrochemical formulation. The agrochemical formulation typically comprises the O/W-emulsifier in a concentration of from 1 to 12 wt %, preferably 1 to 10 wt %, more preferably 2 to 7 wt % based on the total weight of the agrochemical formulation.

The weight ratio of the O/W-emulsifier to the water-immiscible solvent in the agrochemical formulation is typically from 1:1 to 1:20, preferably from 1:5 to 1:15, more preferably from 1:7 to 1:12.

The agrochemical formulation also comprises a suspending agent. Suitable suspending agents are compounds that have a high affinity to the agrochemical active without dissolving it in the continuous oil phase. The suspending agent is typically non-ionic and readily dissolvable in the continuous oil phase.

Examples of suitable suspending agents are N-hydroxyalkyl amides of saturated and unsaturated fatty acids, preferably N,N-bisdihydroxyethyl amides of saturated and unsaturated fatty acids (e.g. Surfom OD 8104); ethoxylated sorbitans partial esters and peresters, preferably ethoxylated sorbitans oleates (e.g. Atlas G 1096, Atlas G 1086, or Arlatone TV); ethoxylated glycerol esters of hydroxy fatty acids and their derivatives, such as ethoxylated castor oil, ethoxylated and hydrogenated castor oil, or ethoxylated castor oil oleate (e.g. Alkamuls VO 2003); and alkoxylated fatty alcohols and alkyl-aryl-sulfonates or mixtures thereof (e.g. Atlox 3467), fatty alcohol alkoxylates, preferably ethoxylated C₈-C₁₈ alcohols, such as ethoxylated isodecyl and isododecyl alcohol (e.g. Foryl 5999, Lutensol ON 50, Tensiofix NTM, or Tensiofix 96DB10), and alkoxylated polyolefins, such as polyisobutylene succinic anhydride-polyethylene glycol (e.g. Atlox 4914)

The agrochemical formulation typically contains the suspending agent in a concentration of from at least 1 wt %, preferably at least 3 wt %, more preferably at least 5 wt %, most preferably at least 10 wt % based on the total weight of the agrochemical formulation. The agrochemical formulation typically contains the suspending agent in a concentration of up to 20 wt %, preferably up to 15 wt %, more preferably up to 12 wt % based on the total weight of the agrochemical formulation. The agrochemical formulation typically contains the suspending agent in a concentration of from 1 to 20 wt %, preferably 5 to 15 wt % based on the total weight of the agrochemical formulation.

The O/W-emulsifiers, W/O-emulsifiers and suspending agents as described above are all part of the generic class of surfactants. and do not form clearly distinguishable functional groups within this class. Instead, the skilled person knows that these groups of surfactants may overlap and that certain compounds may be suitable to be included for more than one function, e.g. some suspending agents may also act as an O/W-emulsifier.

The total concentration of surfactant, i.e. the sum of suspending agents, O/W-emulsifiers, and W/O-emulsifiers, is typically at least 5 wt %, preferably at least 10 wt %, more preferably at least 15 wt %, most preferably at least 20 wt % based on the total weigh of the agrochemical composition. The total concentration of surfactant is typically up to 40 wt %, preferably up to 30 wt %, more preferably up to 25 wt % based on the total weight of the agrochemical formulation. The total concentration of surfactant is typically from 10 to 35 wt %, preferably from 15 to 30 wt % based on the total weight of the agrochemical formulation.

According to the invention, the agrochemical formulation comprises one or more clays.

Clay minerals are widely distributed in nature, and their applications have been rapidly developed due to their unique physical and chemical properties.

There are different types of clay, depending on their composition and use, and include:
smectite clay.
high smectite clay.
organic derivative of hectorite clay.
organic derivative of a bentonite clay.
bentonite clay, a clay that has high swelling and absorbing properties
organically modified bentonite, for instance stearalkonium bentonite.

In one embodiment, suitable clays are unmodified clays like montmorillonite clays, e.g. bentonite, smectite or hectorite clays.

The modification of clay minerals by engineering methods can significantly improve their surface properties that consequently increase more adsorption sites and functional groups, consequently their efficiencies.

The methods for obtaining modified clay to stimulate the activity of clay minerals, include
high-temperature excitation,
acid-base excitation,
interlayer ion exchange,
surface grafting techniques such as sol-gel,
surface hydroxyl grafting,
in situ polymerization intercalation.

The production of functionalized clays such as pillared clays and porous clay heterostructures introduce the new class with high adsorption capacity, capability, and selectivity.

Clays that have been modified using one or more of the above methods are sometimes also referred to as “highly beneficiated clays”.

In one embodiment, modified clays are organoclays.

In one embodiment, suitable clays for use in formulations of the invention are clays that have been modified with one or more methods given above.

In one embodiment suitable clays for use in formulations of the invention include organo clays.

Clays that have been modified by one or more methods given above and organo clays are herein referred to as “modified clays”.

In one embodiment, suitable clays are modified clays.

In one embodiment, suitable clays are highly beneficiated clays.

In one embodiment, suitable clays are organo clays.

The term “organo clay” as used herein means an organically modified phyllosilicate, derived from a naturally occurring clay mineral.

Typically, organoclays are prepared by exchanging the original interlayer cations for organocations (typically quaternary alkylammonium ions), thus generating an organophilic surface comprising covalently linked organic moieties. The lamellar structure typically remains analogous to the parent phyllosilicate.

In one embodiment, said organo clay is an organo bentonite, organo hectorite or organo smectite.

In one embodiment, said organo clay is an organo bentonite.

In one embodiment, said organo clay is prepared by reacting an inorganic clay, especially a bentonite, hectorite or smectite, particularly a bentonite, with a quaternary ammonium salt. An example of such quaternary ammonium salts is stearalkonium. An example of suitable organo clays is stearalkonium bentonite.

Typically said clay, especially modified clay like organo clay, is comprised in the formulation in an amount of more than 1 wt %, typically of 1 to 15 wt % or 1.1 to 15 wt %, based on the formulation, preferably 1.2 to 12 wt %, more preferably 1.5 to 10 wt % or 2 to 8 wt % or 1.5 to 5 wt %.

It is a surprising result of the present invention that clays, especially modified clays like organo clays or highly beneficiated clays, can efficiently stabilize agrochemical formulations comprising emulsified water droplets, since it is known from the art that the presence of dispersants often impedes the use of organo clays as thickeners in oil media. These difficulties have inter alia been described in WO 2019/108500.

It was also a surprising finding that such clays, especially modified clays like organo clays, are effective in such low amounts.

In one embodiment, the clay, especially modified clay like organo clay, is subjected to comminuting or milling to activate it.

In one embodiment the agrochemical formulation comprises
a) a continuous oil phase comprising a water-immiscible solvent;
b) an agrochemical active in the form of particles, which particles are suspended in the continuous oil phase;
c) water droplets that are emulsified in the continuous oil phase; and
d) a water-in-oil emulsifier
e) a clay, especially a modified clay.

In one embodiment the agrochemical formulation comprises
a) a continuous oil phase comprising a water-immiscible solvent;
b) an agrochemical active in the form of particles, which particles are suspended in the continuous oil phase;
c) water droplets that are emulsified in the continuous oil phase; and
d) a water-in-oil emulsifier
e) an organo clay.

In one embodiment, the agrochemical formulation comprises
a) a continuous oil phase comprising a water-immiscible solvent;
b) an agrochemical active in the form of particles, which particles are suspended in the continuous oil phase;
c) water droplets that are emulsified in the continuous oil phase; and
d) a water-in-oil emulsifier; and
d2) a suspending agent.
e) a clay, especially a modified clay.

In one embodiment, the agrochemical formulation comprises
a) a continuous oil phase comprising a water-immiscible solvent;
b) an agrochemical active in the form of particles, which particles are suspended in the continuous oil phase;
c) water droplets that are emulsified in the continuous oil phase; and
d) a water-in-oil emulsifier; and
d2) a suspending agent.
e) an organo clay.

In another embodiment, the agrochemical formulation comprises
a) a continuous oil phase comprising a water-immiscible solvent;
b) an agrochemical active in the form of particles, which particles are suspended in the continuous oil phase;
c) water droplets that are emulsified in the continuous oil phase; and
d) a water-in-oil emulsifier;
d2) a suspending agent; and
d3) an oil-in-water emulsifier.
e) a clay, especially a modified clay.

In another embodiment, the agrochemical formulation comprises
a) a continuous oil phase comprising a water-immiscible solvent;
b) an agrochemical active in the form of particles, which particles are suspended in the continuous oil phase;
c) water droplets that are emulsified in the continuous oil phase; and
d) a water-in-oil emulsifier;
d2) a suspending agent; and
d3) an oil-in-water emulsifier.
e) an organo clay.

In one embodiment, the agrochemical formulation comprises a) 20 to 90 wt % of water-immiscible solvent;
b) 1 to 70 wt % of an agrochemical active in the form of particles, which particles are suspended in the continuous oil phase;
c) 1 to 50 wt % of water droplets that are emulsified in the continuous oil phase;
d) 5 to 40 wt % of dispersants;
e) 1.1 to 15 wt % of a clay, especially a modified clay;
each concentration based on the total weight of the agrochemical formulation.

In one embodiment, the agrochemical formulation comprises a) 20 to 90 wt % of water-immiscible solvent;
b) 1 to 70 wt % of an agrochemical active in the form of particles, which particles are suspended in the continuous oil phase;
c) 1 to 50 wt % of water droplets that are emulsified in the continuous oil phase;
d) 5 to 40 wt % of dispersants;
e) 1.1 to 15 wt % of an organo clay;
each concentration based on the total weight of the agrochemical formulation.

In one embodiment, the agrochemical formulation comprises
a) 20 to 80 wt % of a continuous oil phase comprising a water-immiscible solvent;
b) 1 to 60 wt % of an agrochemical active in the form of particles, which particles are suspended in the continuous oil phase;
c) 3 to 30 wt % of water droplets that are emulsified in the continuous oil phase;
d) 5 to 30 wt % of dispersants;
e) 2 to 12 wt % of a clay, especially a modified clay;
each concentration based on the total weight of the agrochemical formulation.

In one embodiment, the agrochemical formulation comprises
a) 20 to 80 wt % of a continuous oil phase comprising a water-immiscible solvent;
b) 1 to 60 wt % of an agrochemical active in the form of particles, which particles are suspended in the continuous oil phase;
c) 3 to 30 wt % of water droplets that are emulsified in the continuous oil phase;
d) 5 to 30 wt % of dispersants;
e) 2 to 12 wt % of an organo clay;
each concentration based on the total weight of the agrochemical formulation.

The agrochemical formulation is prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005. Typically, the water-immiscible solvent, the agrochemical active, the clay, especially modified clay like organo clay, and optionally some or all of the one or more dispersants are contacted in a first step a) to form a premix. The contacting may for example be achieved by mixing, shaking, or just by adding the agrochemical active to the water-immiscible solvent.

In one embodiment, the water-immiscible solvent, the agrochemical active, the organo clay and optionally some or all of the one or more dispersants are contacted in a first step a) to form a premix. The contacting may for example be achieved by mixing, shaking, or just by adding the agrochemical active to the water-immiscible solvent.

In subsequent step b), the premix is milled to form a raw suspension of the agrochemical active. The milling may for example be done in typical milling devices, such as ball mills, bead mills, rod mills, semi- and autogenous mills, pebble mills, grinding roll mills, Buhrstone mills, tower mills, hammer mills, planetary mills, vertical-shaft-impactor mills, colloid mills, cone mills, disk mills, edge mills, jet mills, pellet mills, stirred mills, three roll mills, vibratory mills, Wiley mills or similar milling and grinding devices known by the skilled person.

In step c), water is then emulsified in the raw suspension obtained in step b). Step c) typically comprises the sub-steps c1) of addition of water to the raw suspension, followed by c2) the formation of water droplets in the continuous oil phase by emulsification. Emulsification may be achieved by intense mixing, shaking, or milling in dispersing devices. To facilitate the emulsification of the water in the continuous oil phase, a W/O-emulsifier may be added in any step of the method for preparing the agrochemical formulation. Preferably, the W/O-emulsifier is added before step c1). The W/O-emulsifier may be added in step a), step b), or step c). If the W/O-emulsifier is added in step c), it may be added with the water.

A suspending agent and/or an O/W-emulsifier may be added in any of steps a), b), or c). Typically, the suspending agent is added before or during the milling in step b). The O/W-emulsifier may preferably be added in step a) or step b).

The clay, especially modified clay like organo clay is typically added at during step a). Alternatively, it may be possible to add the clay, especially modified clay like organo clay during step b) or c). However, this typically requires that sufficiently high amounts of energy are applied to the system, e.g. through shear forces, to activate the clay, especially modified clay like organo clay.

In on embodiment, formulations of the inventions are prepared in a process comprising the steps of
a) providing a premix by contacting the agrochemical active, the clay, especially modified clay, the one or more dispersants and the water-immiscible solvent;
b) milling the premix to form a raw suspension; and
c) emulsifying water in the raw suspension.

In on embodiment, formulations of the inventions are prepared in a process comprising the steps of
a) providing a premix by contacting the agrochemical active, the organo clay, the one or more dispersants and the water-immiscible solvent;
b) milling the premix to form a raw suspension; and
c) emulsifying water in the raw suspension.

The invention also relates to a method for stabilizing an oil dispersion comprising the step of a) providing a continuous oil phase containing a clay, especially modified clay like organo clay, and containing solid particles different from organo clays dispersed therein; and b) emulsifying water droplets in the continuous oil phase.

In one embodiment, the invention also relates to a method for stabilizing an oil dispersion comprising the step of a) providing a continuous oil phase containing an organo clay and containing solid particles different from organo clays dispersed therein; and b) emulsifying water droplets in the continuous oil phase.

In one embodiment, the invention relates to a method for stabilizing an oil dispersion comprising the step of a) providing a continuous oil phase containing a clay, especially modified clay like organo clay, and containing solid particles of one or more pesticides dispersed therein; and b) emulsifying water droplets in the continuous oil phase.

In one embodiment, the invention relates to a method for stabilizing an oil dispersion comprising the step of a) providing a continuous oil phase containing an organo clay and containing solid particles of one or more pesticides dispersed therein; and b) emulsifying water droplets in the continuous oil phase.

The term “increasing the stability” usually refers to the physical stability of the dispersion, e.g. an improvement of the settling behavior of the dispersed particles.

The invention also relates to a method for increasing the viscosity (preferably the dynamic viscosity) of a continuous oil phase (preferably of an oil dispersion) comprising the steps of a) providing a continuous oil phase; and b) emulsifying water droplets in the continuous oil phase, wherein the continuous oil phase comprises a clay, especially modified clay like organo clay.

In one embodiment, the invention also relates to a method for increasing the viscosity (preferably the dynamic viscosity) of a continuous oil phase (preferably of an oil dispersion) comprising the steps of a) providing a continuous oil phase; and b) emulsifying water droplets in the continuous oil phase, wherein the continuous oil phase comprises an organo clay.

Suitable means and methods for emulsifying the water-droplets in the continuous oil phase are as outlined above. Typically, the method comprises adding a W/O-emulsifier.

The invention also relates to the use of emulsified water droplets to increase the viscosity (preferably the dynamic viscosity) of an oil dispersion comprising a clay, especially modified clay like organo clay.

The invention also relates to the use of emulsified water droplets to increase the viscosity (preferably the dynamic viscosity) of an oil dispersion comprising an organo clay.

The agrochemical formulation may comprise further auxiliaries. Suitable auxiliaries solid carriers or fillers, surfactants, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, UV filters, tackifiers and binders.

Suitable solid carriers or fillers include mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharides, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants include surface-active compounds, such as anionic, cationic, non-ionic and amphoteric surfactants, block polymers, polyelectrolytes, and mixtures thereof. Such surfactants can be used as emulsifier, suspending agent, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants include alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignin sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkyl-naphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable non-ionic surfactants include alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may for example be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants include quaternary surfactants, for example quaternary ammonium compounds with one or two hydrophobic groups, or salts of long-chain primary amines. Suitable amphoteric surfactants are alkylbetains and imidazolines. Suitable block polymers include block polymers of the A-B or A-B-A type comprising blocks of polyethylene oxide and polypropylene oxide, or of the A-B-C type comprising alkanol, polyethylene oxide and polypropylene oxide. Suitable polyelectrolytes include polyacids or polybases. Examples of polyacids are alkali salts of polyacrylic acid or polyacid comb polymers. Examples of polybases are polyvinylamines or polyethyleneamines.

Adjuvants are compounds, which have a neglectable or even no pesticidal activity themselves, and which improve the biological performance of the compound I on the target. Examples are surfactants, mineral or vegetable oils, and other auxiliaries. Further examples are listed by Knowles, Adjuvants and additives, Agrow Reports DS256, T&F Informa UK, 2006, chapter 5.

In one embodiment, the agrochemical formulation is substantially free of further thickeners, meaning thickeners different from water droplets and clays, especially modified clays like organo clay. The term “substantially free” as used herein typically relates to an agrochemical formulation comprising further thickeners to a concentration of not more than 1 wt %, more preferably not more than 0.1 wt %, most preferably not more than 0.01 wt %, each time based on the total weight of the agrochemical composition. In one embodiment, the agrochemical formulation does not contain a further thickener.

The term “further thickener(s)” usually refers to inorganic clays, such as bentonites, hectorite and smectite clays, and silicates (e.g. colloidal hydrous magnesium silicate, colloidal hydrous aluminium silicate, colloidal hydrous aluminium magnesium silicate, hydrous amorphous silicon dioxide); and organic clays, such as polycarboxylates (e.g. poly(meth)acrylates and modified poly(meth)acrylates), polysaccharides (e.g. xanthan gum, agarose, rhamsan gum, pullulan, tragacanth gum, locust bean gum, guar gum, tara gum, Whelan cum, casein, dextrin, diutan gum, cellulose, ethyl cellulose, hydroxyethylcellulose, methylhydroxypropylcellulose), polyvinyl ethers, polyvinyl pyrrolidone, polypropylene oxide-polyethylene oxide condensates, polyvinyl acetates, maleic anhydrides, polypropylene glycols, polyacrylonitrile block copolymers, proteins, and carbohydrates.

On a functional level, the term “thickener” as used herein refers to a compound that increases the dynamic viscosity of a liquid composition if added, as compared to the same liquid composition without the compound.

A thickener may be defined as a compound that increases the dynamic viscosity of water of at least 0.1 mPas at 25 °C and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 0.5 mPas at 25 °C and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 1 mPas at 25 °C and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 5 mPas at 25 °C and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 10 mPas at 25 °C and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 25 mPas at 25 °C and at a shear rate of 100/second, if the thickener is added at to the water at a concentration of 1 wt %, wherein the water has a standard water hardness according to CIPAC of 342 ppm and a pH of 6.0-7.0.

In one embodiment, the thickener increases the dynamic viscosity of water of at least 50 mPas at 25 °C and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 100 mPas at 25 °C and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 250 mPas at 25 °C and at a shear rate of 100/second, if the thickener is added at to the water at a concentration of 1 wt %, wherein the water has a standard water hardness according to CIPAC of 342 ppm and a pH of 6.0-7.0.

A thickener may also be defined as a compound that increases the dynamic viscosity of soybean oil methyl ester of at least 0.1 mPas at 25 °C and at a shear rate of 100/second, if the thickener is added at to the soybean oil methyl ester at a concentration of 1 wt %. In one embodiment, the thickener increases the dynamic viscosity of soybean oil methyl ester of at least 0.5 mPas at 25 °C and at a shear rate of 100/second, if the thickener is added at to the soybean oil methyl ester at a concentration of 1 wt %. In one embodiment, the thickener increases the dynamic viscosity of soybean oil methyl ester of at least 1 mPas at 25 °C and at a shear rate of 100/second, if the thickener is added at to the soybean oil methyl ester at a concentration of 1 wt %. In one embodiment, the thickener increases the dynamic viscosity of soybean oil methyl ester of at least 5 mPas at 25 °C and at a shear rate of 100/second, if the thickener is added at to the soybean oil methyl ester at a concentration of 1 wt %. In one embodiment, the thickener increases the dynamic viscosity of soybean oil methyl ester of at least 10 mPas at 25 °C and at a shear rate of 100/second, if the thickener is added at to the soybean oil methyl ester at a concentration of 1 wt %. In one embodiment, the thickener increases the dynamic viscosity of soybean oil methyl ester of at least 25 mPas at 25 °C and at a shear rate of 100/second, if the thickener is added at to the soybean oil methyl ester at a concentration of 1 wt %. In one embodiment, the thickener increases the dynamic viscosity of soybean oil methyl ester of at least 50 mPas at 25 °C and at a shear rate of 100/second, if the thickener is added at to the soybean oil methyl ester at a concentration of 1 wt %. In one embodiment, the thickener increases the dynamic viscosity of soybean oil methyl ester of at least 100 mPas at 25 °C and at a shear rate of 100/second, if the thickener is added at to the soybean oil methyl ester at a concentration of 1 wt %. In one embodiment, the thickener increases the dynamic viscosity of soybean oil methyl ester of at least 250 mPas at 25 °C and at a shear rate of 100/second, if the thickener is added at to the soybean oil methyl ester at a concentration of 1 wt %.

A thickener may be defined as a compound that increases the dynamic viscosity of water or soybean oil methyl ester of at least 0.1 mPas at 25 °C and at a shear rate of 100/second, if the thickener is added at to the water or the soybean oil methyl ester at a concentration of 1 wt %, wherein the water has a standard water hardness according to CIPAC of 342 ppm and a pH of 6.0-7.0. In one embodiment, the thickener increases the dynamic viscosity of water or soybean oil methyl ester of at least 0.5 mPas at 25 °C and at a shear rate of 100/second, if the thickener is added at to the water or the soybean oil methyl ester at a concentration of 1 wt %, wherein the water has a standard water hardness according to CIPAC of 342 ppm and a pH of 6.0-7.0.

In one embodiment, the thickener increases the dynamic viscosity of water or soybean oil methyl ester of at least 1 mPas at 25 °C and at a shear rate of 100/second, if the thickener is added at to the water or the soybean oil methyl ester at a concentration of 1 wt %, wherein the water has a standard water hardness according to CIPAC of 342 ppm and a pH of 6.0-7.0.

In one embodiment, the thickener increases the dynamic viscosity of water or soybean oil methyl ester of at least 5 mPas at 25 °C and at a shear rate of 100/second, if the thickener is added at to the water or the soybean oil methyl ester at a concentration of 1 wt %, wherein the water has a standard water hardness according to CIPAC of 342 ppm and a pH of 6.0-7.0.

In one embodiment, the thickener increases the dynamic viscosity of water or soybean oil methyl ester of at least 10 mPas at 25 °C and at a shear rate of 100/second, if the thickener is added at to the water or the soybean oil methyl ester at a concentration of 1 wt %, wherein the water has a standard water hardness according to CIPAC of 342 ppm and a pH of 6.0-7.0.

In one embodiment, the thickener increases the dynamic viscosity of water or soybean oil methyl ester of at least 25 mPas at 25 °C and at a shear rate of 100/second, if the thickener is added at to the water or the soybean oil methyl ester at a concentration of 1 wt %, wherein the water has a standard water hardness according to CIPAC of 342 ppm and a pH of 6.0-7.0.

In one embodiment, the thickener increases the dynamic viscosity of water or soybean oil methyl ester of at least 50 mPas at 25 °C and at a shear rate of 100/second, if the thickener is added at to the water or the soybean oil methyl ester at a concentration of 1 wt %, wherein the water has a standard water hardness according to CIPAC of 342 ppm and a pH of 6.0-7.0.

In one embodiment, the thickener increases the dynamic viscosity of water or soybean oil methyl ester of at least 100 mPas at 25 °C and at a shear rate of 100/second, if the thickener is added at to the water or the soybean oil methyl ester at a concentration of 1 wt %, wherein the water has a standard water hardness according to CIPAC of 342 ppm and a pH of 6.0-7.0.

In one embodiment, the thickener increases the dynamic viscosity of water or soybean oil methyl ester of at least 250 mPas at 25 °C and at a shear rate of 100/second, if the thickener is added at to the water or the soybean oil methyl ester at a concentration of 1 wt %, wherein the water has a standard water hardness according to CIPAC of 342 ppm and a pH of 6.0-7.0.

For the avoidance of doubt, the term “thickener” does not relate to the water droplets that are emulsified in the continuous oil phase.

The dynamic viscosity according to the invention is usually measured by means of a Brookfield viscosimeter, i.e. a rotational viscosimeter with a cone-plate geometry. The dynamic viscosity may be determined according to industry standard EN ISO 2555:2018. Usually, the dynamic viscosity is measured at 25 °C. In this method, the shear rate of the rotation viscosimeter is constantly increased and the shear stress is measured. For Newtonian Fluids, the measurement results in a linear dataset according to a direct proportionality between the shear stress and the shear rate. For non-Newtonian fluids, the measurement results in a non-linear dependency between shear stress and shear rate. The dynamic viscosity, also called apparent viscosity, is typically determined by measuring the slope of a line through the origin of the coordinate system and the shear stress as determined at a shear rate of 100/second. The true viscosity, which may be different from the apparent viscosity for non-Newtonian fluids, is determined by calculating the slope of the tangent of the experimental curve as measured at a shear rate of 100/second.

The agrochemical formulation usually has a true viscosity of from 60 mPas to 1000 mPas, preferably from 60 mPas to 900 mPas, more preferably from 80 to 800 mPas. The agrochemical formulation usually has an apparent viscosity of from 80 mPas to 2000 mPas, preferably from 100 mPas to 1500 mPas, more preferably from 150 mPas to 1000 mPas, most preferably from 200 mPas to 800 mPas, in each case for the apparent viscosity at a shear rate of 100/second.

Suitable bactericides include bronopol and isothiazolinone derivatives such as alkylisothiazolinones and benzisothiazolinones.

Suitable anti-freezing agents include ethylene glycol, propylene glycol, urea and glycerin. Suitable anti-foaming agents are silicones, long chain alcohols, and salts of fatty acids.

Suitable colorants (e.g. in red, blue, or green) include pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

The term “UV filters” is understood as meaning inorganic or organic substances which are able to absorb ultraviolet rays and give off the absorbed energy again in the form of longer-wave radiation, e.g. heat. The term “UV filter” relates to one type or a mixture of different types of said compounds. Suitable examples of UV filters include a) benzotriazoles, such as 2-(2H-benzotriazol-2-yl)-4,6-bis(1-methyl-1-phenylethyl)phenol (Tinuvin® 900, CIBA AG), [3-[3-(2H-benzotriazol-2-yl)-5-(1,1-dimethylethyl)-4-hydroxyphenyl]-1-oxopropyl]-w-[3-[3-(2Hbenzotriazol-2-yl)-5-(1,1-dimethylethyl)-4-hydroxyphenyl]-1-oxopropoxy]poly(oxy-1,2-ethanediyl) (Tinuvin® 1130, CIBA AG), 6-tert.-butyl-2-(5-chloro-2H-benzotriazol-2-yl)-4-methylphenol, 2,4-di-tert-butyl-6-(5-chloro-2H-benzotriazol-2-yl)-phenol, 2-(2H-benzotriazol-2-yl)-4,6-di-tert.-pentylphenol, 2-(2H-benzotriazol-2-yl)-4-(1,1,3,3-tetramethylbutyl)-phenol, 2-(2H-benzotriazol-2-yl)-4-methylphenol, 2-(2H-benzotriazol-2-yl)-4,6-bis(1-methyl-1-phenylethyl)phenol; b) cyanoacrylate derivatives, such as ethyl 2-cyano-3-phenylcinnamate (Uvinul® 3035, BASF SE), 2-cyano-3,3-diphenylacrylic acid-2′-ethylhexyl ester or 2-ethylhexyl 2-cyano-3-phenylcinnamate (octocrylene, Uvinul® 539 T, Uvinul 3039, BASF SE); c) para-aminobenzoic acid (PABA) derivatives, especially esters, such as ethyl-PABA, ethoxylated PABA, ethyl-dihydroxypropyl-PABA, Glycerol-PABA, 2-ethylhexyl 4-(dimethylamino)benzoate (Uvinul® MC 80), 2-octyl-4-(dimethylamino)benzoate, amyl 4-(dimethylamino)benzoate, 4-bis(polyethoxy)-4-amino benzoic acid polyethoxyethyl ester (Uvinul® P 25, BASF SE); d) esters of salicylic acid, such as 2-ethylhexyl salicylate, 4-isopropylbenzyl salicylate, homomenthyl salicylate, TEA salicylate (Neo Heliopan® TS, Haarmann and Reimer), dipropyleneglycol salicylate; e) esters of cinnamic acid, such as 2-ethylhexyl 4-methoxycinnamate (Uvinul® MC 80), octyl-p-methoxycinnamate, propyl 4-methoxycinnamate, isoamyl-4-methoxycinnamate, conoxate, diisopropyl methylcinnamate, etocrylene (Uvinul® N 35, BASF SE); f) derivatives of benzophenone, such as 2-hydroxy-4-methoxybenzophenone (Uvinul® M 40, BASF SE), 2-hydroxy-4-methoxy-4′-methylbenzophenone, 2,2′-dihydroxy-4-methoxybenzophenone, 2-(4-diethylamino-2-hydroxybenzoyl)-benzoic acid hexylester (Uvinul® A Plus, BASF SE), 4-n-octyloxy-2-hydroxy-benzophenone (Uvinul® 3008, BASF SE), 2-hydroxybenzophenone derivatives such as 4-hydroxy-, 4-methoxy-, 4-octyloxy-, 4-decyloxy-, 4-dodecyloxy-, 4-benzyloxy-, 4,2′,4′-trihydroxy-; 2′-hydroxy-4,4′-dimethoxy-2-hydroxybenzophenone; g) sulfonic acid derivatives of benzophenones, such as 2-hydroxy-4-methoxybenzo-phenone-5-sulfonic acid (Uvinul® MS 40, BASF SE) and its salts, 2,2′-dihydroxy-4,4′-dimethoxybenzophenone-5,5′-sulfonic acid and its salts (disodium salt: Uvinul® DS 49, BASF SE); h) 3-benzylidenecamphor and derivatives thereof, such as 3-(4′-methylbenzylidene)d-1-camphor, benzylidiene camphor sulfonic acid (Mexoryl® SO, Chimex); j) sulfonic acid derivatives of 3-benzylidenecamphor, such as 4-(2-oxo-3-bornylidenemethyl)benzenesulfonic acid and 2-methyl-5-(2-oxo-3-bornylidene)sulfonic acid and salts thereof; k) esters of benzalmalonic acid, such as 2-ethylhexyl 4-methoxybenzmalonate; m) triazine derivatives, such as dioctylbutamidotriazone (Uvasorb® HEB, Sigma), 2,4,6-trinanilino-p-(carbo-2′-ethyl-hexyl-1′-oxy)-1,3,5-triazine (Uvinul® T 150, BASF SE), 2-[4-[(2-Hydroxy-3-(2′-ethyl)hexyl)oxy]-2-hydroxyphenyl]-4,6bis(2,4-dimethylphenyl)-1,3,5-triazine (Tinuvin® 405, CIBA AG), anisotriazine (Tinosorb® S, CIBA AG), 2,4,6-tris(diisobutyl-4′-aminobenzalmalonate)-s-triazine; n) propane-1,3-diones, such as, 1-(4-tert-butylphenyl)-3-(4′-methoxyphenyl)propane-1,3-dione; o) 2-phenylbenzimidazole-5-sulfonic acid or 2-phenylbenzimidazole-4-sulfonic acid and alkali metal, alkaline earth metal, ammonium, alkylammonium, alkanol ammonium and glucammonium salts thereof; p) derivatives of benzoyl methane, such as, 1-(4′-tert-butylphenyl)-3-(4′-methoxyphenyl)propane-1,3-dione, 4-tert-butyl-4′-methoxydibenzoylmethane or

1-phenyl-3-(4′-isopropylphenyl)propane-1,3-dione; q) aminohydroxy-substituted derivatives of benzophenones, such as N,N-diethylaminohydroxybenzoyl-n-hexylbenzoate; r) inorganic absorbers e.g. based on ZnO (e.g. Z-Cote® products, BASF SE), TiO₂ (e.g. T-Lite™ products, BASF SE) or CeO₂; and s) mixtures of UV filters of groups a) to r), such as a mixture of p-methoxy cinnamic acid ethylhexyl ester (65%) and 2-(4-diethylamino-2-hydroxybenzoyl)benzoic acid hexylester (35%) (Uvinul® A Plus B, BASF SE);

Suitable tackifiers or binders include polyvinylpyrrolidons, polyvinylacetates, polyvinyl alcohols, polyacrylates, biological or synthetic waxes, and cellulose ethers.

The invention also relates to a method for controlling phytopathogenic fungi and/or undesired plant growth and/or undesired attack by insects or mites and/or for regulating the growth of plants, where the agrochemical formulation is allowed to act on the particular pests, their habitat or the plants to be protected from the particular pest, the soil and/or on undesired plants and/or the useful plants and/or their habitat. In one embodiment, the method is for controlling phytopathogenic fungi. In another embodiment, the method is for controlling undesired vegetation. In another embodiment, the method is for controlling undesired attach by insects or mites.

These methods typically comprise the treatment of the plant to be protected, its locus of growth, the phytopathogenic fungi and/or undesired plant growth and/or undesired attack by insects or mites with the agrochemical formulation.

Suitable methods of treatment include inter alia soil treatment, seed treatment, in furrow application, and foliar application. Soil treatment methods include drenching the soil, drip irrigation (drip application onto the soil), dipping roots, tubers or bulbs, or soil injection. Seed treatment techniques include seed dressing, seed coating, seed dusting, seed soaking, and seed pelleting. In furrow applications typically include the steps of making a furrow in cultivated land, seeding the furrow with seeds, applying the pesticidally active compound to the furrow, and closing the furrow.

In one embodiment of the method of application, the plant is an agricultural plant and/or the propagation material relates to propagation material of such agricultural plants, wherein the agricultural plant is selected from wheat, barley, oat, rye, soybean, corn, potatoes, oilseed rape, canola, sunflower, cotton, sugar cane, sugar beet, rice or a vegetable such as spinach, lettuce, asparagus, or cabbages; or sorghum; a silvicultural plant; an ornamental plant; and a horticultural plant, each in its natural or in a genetically modified form.

In one embodiment, the plant to be treated according to the method of the invention is an agricultural plant. “Agricultural plants” are plants of which a part (e.g. seeds) or all is harvested or cultivated on a commercial scale or which serve as an important source of feed, food, fibers (e.g. cotton, linen), combustibles (e.g. wood, bioethanol, biodiesel, biomass) or other chemical compounds. Preferred agricultural plants are for example cereals, e.g. wheat, rye, barley, triticale, oats, corn, sorghum or rice, beet, e.g. sugar beet or fodder beet; fruits, such as pomes, stone fruits or soft fruits, e.g. apples, pears, plums, peaches, almonds, cherries, strawberries, raspberries, blackberries or gooseberries; leguminous plants, such as lentils, peas, alfalfa or soybeans; oil plants, such as rape, oil-seed rape, canola, linseed, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, canola, sugar cane or oil palm; tobacco; nuts; coffee; tea; bananas; vines (table grapes and grape juice grape vines); hop; turf; natural rubber plants.

In a further embodiment, the plant to be treated according to the method of the invention is a horticultural plant. The term “horticultural plants” are to be understood as plants which are commonly used in horticulture, e.g. the cultivation of ornamentals, vegetables and/or fruits. Examples for ornamentals are turf, geranium, pelargonia, petunia, begonia and Fuchsia. Examples for vegetables are potatoes, tomatoes, peppers, cucurbits, cucumbers, melons, watermelons, garlic, onions, carrots, cabbage, beans, peas and lettuce and more preferably from tomatoes, onions, peas and lettuce. Examples for fruits are apples, pears, cherries, strawberry, citrus, peaches, apricots and blueberries.

In a further embodiment, the plant to be treated according to the method of the invention is an ornamental plant. “Ornamental plants” are plants which are commonly used in gardening, e.g. in parks, gardens and on balconies. Examples are turf, geranium, pelargonia, petunia, begonia and Fuchsia.

In another embodiment of the present invention, the plant to be treated according to the method of the invention is a silvicultural plant. The term “silvicultural plant” is to be understood as trees, more specifically trees used in reforestation or industrial plantations. Industrial plantations generally serve for the commercial production of forest products, such as wood, pulp, paper, rubber tree, Christmas trees, or young trees for gardening purposes. Examples for silvicultural plants are conifers, like pines, in particular Pinus spec., fir and spruce, eucalyptus, tropical trees like teak, rubber tree, oil palm, willow (Salix), in particular Salix spec., poplar (cottonwood), in particular Populus spec., beech, in particular Fagus spec., birch, oil palm, and oak.

When employed in plant protection, the amounts of agrochemical active applied are typically, depending on the kind of effect desired, from 0.001 to 2 kg per ha, preferably from 0.005 to 2 kg per ha, more preferably from 0.05 to 0.9 kg per ha, and in particular from 0.1 to 0.75 kg per ha.

When used in the protection of materials or stored products, the amount of active substance applied depends on the kind of application area and on the desired effect. Amounts customarily applied in the protection of materials are 0.001 g to 2 kg, preferably 0.005 g to 1 kg, of active substance per cubic meter of treated material.

Various types of oils, wetters, adjuvants, fertilizer, or micronutrients, and further pesticides (e.g. herbicides, insecticides, fungicides, growth regulators, safeners) may be added to the active substances or the compositions comprising them as premix or, if appropriate not until immediately prior to use (tank mix). These agents can be admixed with the compositions according to the invention in a weight ratio of 1:100 to 100:1, preferably 1:10 to 10:1.

The user applies the composition according to the invention usually from a predosage device, a knapsack sprayer, a spray tank, a spray plane, a drone, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

Advantages of the present invention include the following:
formulations of the invention are easy and economical to make
formulations of the invention are environmentally friendly
formulations of the invention have a high storage stability
formulations of the invention have a high storage stability especially at temperatures above 30 °C or 40 °C or 50 °C
formulations of the invention do not gel upon dilution with water,
Formulations of the invention have a high storage stability ad varying viscosities.
Formulations of the invention are easy to handle, applicate and to manufacture.
no thickening agent is required beside organic clays and water,
no biocide is required,
agrochemical actives that degrade over time in the presence of water can be stabilized as compared to formulations having a continuous aqueous phase.
It allows the formulation of complex pesticide mixtures.

The following examples illustrate the invention.

Materials used:
Suspending Agent A: Polyoxyethylene sorbitol hexaoleate, 50 ethylene oxide moieties per molecule
Suspending agent B: Ethoxylated (3-13) EO fatty acid (C8 to C18) methyl ester
O/W-Emulsifier A: blend of calcium alkylarylsulfonate and of fatty alcohol ethoxylate
W/O Emulsifier A: castor oil ethoxylate (10 EO)
W/O-Emulsifier B: castor oil ethoxylate (20 EO), HLB of 10
Solvent A: soybean oil methyl ester
Thickener A: hydroxypropyl methylcellulose with an amount of substituent groups on the anhydroglucose units of cellulose of 7 to 12 wt % hydroxyl propyl and of 18 to 24 wt % methoxy
Thickener B: Organic derivative of bentonite clay
Thickener C: Dextrin, CAS No. 9004-53-9
Thickener D: Maltodextrin, CAS No. 9050-36-6
Thickener E: hydroxypropyl methylcellulose with an amount of substituent groups on the anhydroglucose units of cellulose of 25 to 32 wt % hydroxyl propyl and of 22 to 27 wt % methoxy
Thickener F: Organic derivative of bentonite clay
Thickener G: refined Smectite Clay

### EXAMPLES 1-2, 5-16

### Preparation of Agrochemical Formulations

The agrochemical formulations were prepared as follows. The solvent was mixed with the pesticides, the suspending agent, the O/W-emulsifier and the thickener in the amounts given in Table 1 to obtain a premix. Mixing was performed with a stirrer. A volume of 250 ml of the premix was then milled with a Getzmann basket mill at 4000 rpm for 2 h minutes at a maximum temperature of 35 °C under addition of 28 ml of zirconium oxide beads with a diameter of 1.0 to 1.2 mm. Subsequently, the W/O-emulsifier was added to the raw suspension and the resulting composition was again mixed with a stirrer under the addition of water. After the complete amount of water had been added, the agrochemical formulation was mixed with an Ultra-Turrax T18 device for another two minutes at 11,000 rpm.

In the case of Thickeners C, D and E (examples 6, 7, 8), the solvent was mixed with the thickener (5% w/w) and stirred 2 hours, yet no thickening effect was observed, emulsification of water was not carried out.

### EXAMPLES 3-4

### Preparation of Agrochemical Formulations

The agrochemical formulations were prepared as follows: The solvent was mixed with the pesticides, the suspending agent and the O/W-emulsifier in the amounts given in Table 1 to obtain a premix. Mixing was performed with a stirrer. A volume of 250 ml of the premix was then milled with a Getzmann basket mill at 4000 rpm for 2 h minutes at a maximum temperature of 35 °C under addition of 28 ml of zirconium oxide beads with a diameter of 1.0 to 1.2 mm. After that a thickening solution was prepared from water and Thickener A. For this, water was heated to 50 °C and Thickener A was added under stirring. Then the mixture was stirred until it was free of lumps and cooled down to 20 °C. Subsequently, the W/O-emulsifier was added to the raw suspension and the resulting composition was again mixed with a stirrer under the addition of the water-/Thickener A-thickening solution. After the complete amount of this solution had been added, the agrochemical formulation was mixed with an Ultra-Turrax T18 device for another two minutes at 11,000 rpm.

### Analytical Methods:

For determining the storage stability (Phase Separation), the samples were stored in transparent bottles without shaking or stirring. Subsequently, the phase separation of the samples was analyzed. For this, the height of the supernatant was measured and compared to the total filling level. The relative phase separation was calculated by dividing the height of the supernatant phase to the total filling height.

The viscosity at 100 s⁻¹ was determined using a cone and plate viscosimeter of the type “Discovery HR 10” from TA Instruments Inc. The diameter of the cone was 60 mm with a cone angle of 2°. The temperature of the sample was allowed to equilibrate at 20 °C for 30 seconds on the plate. Then the shear rate was increased at a constant rate from 0 to 100 s⁻¹ over 120 seconds. After that, the shear rate was kept at 100 s-1 and the shear stress was measured once every second. From the mean value of 10 measurements at 100 s-1, the viscosity was calculated and given as “viscosity at 100 s⁻¹”.

TABLE 1
Composition of formulations 1 to 8, amounts given in grams per liter
(g/l), as well as their storage stabilities and viscosities.

| | Example No. | | | | |
|---|---|---|---|---|---|
| | 1 | 2 | 3 | 4 | 5 |
| Trifludimoxazin | 9 | 9 | 9 | 9 | 9 |
| Saflufenacil | 18 | 18 | 18 | 18 | 18 |
| Pyroxasulfone | 120 | 120 | 120 | 120 | 120 |
| Imazethapyr | 70 | 70 | 70 | 70 | 70 |
| O/W Emulsifier A | 28.33 | 28.33 | 33.33 | 33.33 | 33.33 |
| Suspending Agent A | 28.33 | 28.33 | 33.33 | 33.33 | 33.33 |
| Suspending Agent B | 28.33 | 28.33 | 33.33 | 33.33 | 33.33 |
| Thickener A | | | 2.3 | 2.3 | |
| Thickener B | | | | | 35 |
| Thickener C | | | | | |
| Thickener D | | | | | |
| Thickener E | | | | | |
| W/O Emulsifier A | 100 | | 100 | | |
| W/O-Emulsifier B | | 100 | | 100 | 100 |
| Solvent A | 448 | 448 | 450 | 450 | 468 |
| Water | 150 | 150 | 150 | 150 | 100 |
| Viscosity at 100 s⁻¹ [mPas] | 668 | 1342 | 712 | 1311 | 693 |
| Phase Separation after | 35.3% | 38.8% | 33.3% | 36.7% | 0.0% |
| 2 weeks, 54 °C | | | | | |
| Phase Separation after | 37.7% | 37.7% | 40.0% | 8.88% | 0.0% |
| 8 weeks, 40 °C | | | | | |

| | Example No. | | | |
|---|---|---|---|---|
| | 6 | 7 | 8 | 9 |
| Trifludimoxazine | 9 | 9 | 9 | 9 |
| Saflufenacil | 18 | 18 | 18 | 18 |
| Pyroxasulfone | 120 | 120 | 120 | 120 |
| Imazethapyr | 70 | 70 | 70 | 70 |
| O/W Emulsifier A | 28.33 | 33.33 | 33.33 | 28.33 |
| Suspending Agent A | 28.33 | 33.33 | 33.33 | 28.33 |
| Suspending Agent B | 28.33 | 33.33 | 33.33 | 28.33 |
| Thickener A | | | | |
| Thickener B | | | | 28.2 |
| Thickener C | 2.3 | | | |
| Thickener D | | 2.3 | | |
| Thickener E | | | 2.3 | |
| W/O Emulsifier A | | 100 | | |
| W/O-Emulsifier B | 100 | | 100 | 50 |
| Solvent A | | | | |
| Water | 150 | 150 | 150 | 75 |
| Viscosity at 100 s⁻¹ [mPas] | | | | 309 |
| Phase Separation after | n.b. | n.b. | n.b. | 0.0% |
| 2 weeks, 54 °C | | | | |
| Phase Separation after | n.b. | n.b. | n.b | 0.0% |
| 8 weeks, 40 °C | | | | |
| | Example No. | | | |
| | 10 | 11 | 12 | 13 |
| Trifludimoxazine | 9 | 9 | 9 | 9 |
| Saflufenacil | 18 | 18 | 18 | 18 |
| Pyroxasulfone | 120 | 120 | 120 | 120 |
| Imazethapyr | 70 | 70 | 70 | 70 |
| Suspending Agent A | 28.33 | 28.33 | 28.33 | 28.5 |
| Suspending Agent B | 28.33 | 28.33 | 28.33 | 28.5 |
| O/W Emulsifier A | 28.33 | 28.33 | 28.33 | 28.5 |
| Thickener B | 28.24 | | | |
| Thickener F | | | 20 | |
| Thickener G | | 28.24 | | 25 |
| W/O Emulsifier A | | | | |
| W/O-Emulsifier B | 50 | 50 | 50 | 50 |
| Water | 75 | 75 | 75 | 75 |
| Solvent A | ad. 1 L | ad. 1 L | ad. 1 L | ad. 1 L |
| viscosity at 100 s⁻¹ [mPas] | 500 | 661 | 619 | 722 |
| phase separation after | 0% | 4% | 0% | 8% |
| 2 w, 54 °C | | | | |
| phase separation after | 0% | 7% | 2% | 2% |
| 8 w, 40 °C | | | | |

| | Example No. | | |
|---|---|---|---|
| | 14 | 15 | 16 |
| Trifludimoxazine | 9 | 9 | 9 |
| Saflufenacil | 18 | 18 | 18 |
| Pyroxasulfone | 120 | 120 | 120 |
| Imazethapyr | 70 | 70 | 70 |
| Suspending Agent A | 28.5 | 28.5 | 28.5 |
| Suspending Agent B | 28.5 | 28.5 | 28.5 |
| O/W Emulsifier A | 28.5 | 28.5 | 28.5 |
| Thickener B | | | |
| Thickener F | | | 12.5 |
| Thickener G | 25 | 25 | |
| W/O Emulsifier A | | 50 | |
| W/O-Emulsifier B | 45 | | 50 |
| Water | 75 | 75 | 75 |
| Solvent A | ad. 1 L | ad. 1 L | ad. 1 L |
| viscosity at 100 s⁻¹ [mPas] | 661 | 552 | 642 |
| phase separation after | 4% | 1% | 2% |
| 2 w, 54 °C | | | |
| phase separation after | 4% | 4% | — |
| 8 w, 40 °C | | | |

1. An agrochemical formulation comprising
a. a continuous oil phase comprising a water-immiscible solvent;
b. an agrochemical active in the form of particles, which particles are suspended in the continuous oil phase; and
c. water droplets that are emulsified in the continuous oil phase;
d. one or more dispersants,
e. a clay.

2. The agrochemical formulation of claim 1, where said clay is a modified clay.

3. The agrochemical formulation of claim 1, wherein said clay is an organo clay.

4. The agrochemical formulation of claim 2, wherein said modified clay is present in an amount of 1.1 to 15 wt %, based on the formulation.

5. The agrochemical formulation of claim 2, wherein said modified clay is a modified smectite, a modified hectorite or a modified bentonite.

6. The agrochemical formulation of claim 2, wherein said modified clay is an organo smectite, an organo hectorite or an organo bentonite.

7. The agrochemical formulation of claim 3, wherein said organo clay is prepared by reacting an inorganic clay with a quaternary ammonium salt.

8. The agrochemical formulation of claim 1, containing at least 1 wt % of water based on the total weight of the agrochemical formulation.

9. The agrochemical formulation of claim 1, wherein the particles and have a mean diameter d50 of 0.5 to 10 μm.

10. The agrochemical formulation of claim 1, further comprising a suspending agent.

11. The agrochemical formulation of claim 1, further comprising a water-in-oil emulsifier.

12. The agrochemical formulation of claim 1, further comprising an oil-in-water emulsifier.

13. The agrochemical formulation of claim 1, wherein the agrochemical active is selected from herbicides, fungicides, insecticides, nematicides, plant growth regulators, fertilizers, nitrification inhibitors, or urease inhibitors.

14. The agrochemical formulation of claim 1, wherein the continuous oil phase comprises a water-immiscible solvent selected from hydrocarbon solvents, vegetable oils, fatty acid esters, methyl- or ethyl esters of vegetable oils, and mixtures thereof.

15. The agrochemical formulation of claim 14, wherein the water-immiscible solvent has a water-solubility of up to 10 g/l at 20 °C.

16. The agrochemical formulation of claim 1, wherein the water-droplets have a mean diameter d50 of up to 25 μm.

17. The agrochemical formulation of claim 1, wherein the water-immiscible solvent is present in a concentration of from 20 to 80 wt % based on the total weight of the agrochemical formulation.

18. The agrochemical formulation of claim 1, wherein the agrochemical active is present in a concentration of from 1 to 60 wt % based on the total weight of the agrochemical formulation.

19. A method for preparing the agrochemical formulation of claim 1, comprising the steps of
a. providing a premix by contacting the agrochemical active, the organic clay, the one or more dispersants and the water-immiscible solvent;
b. milling the premix to form a raw suspension; and
c. emulsifying water in the raw suspension.

20. A method for controlling phytopathogenic fungi and/or undesired plant growth and/or undesired attack by insects or mites and/or for regulating the growth of plants, comprising allowing the agrochemical formulation of claim 1 to act on the phytopathogenic fungi, insects, or mites, their habitat, or the plants to be protected from the phytopathogenic fungi, insects, or mites, the soil and/or on undesired plants and/or useful plants and/or their habitat.
